(19) United States
(12) Patent Application Publication
(10) Pub. No.: US 2023/0046341 A1
(43) Pub. Date: Feb. 16, 2023

(54) WORLD LOCK SPATIAL AUDIO PROCESSING

(71) Applicant: Meta Platforms Technologies, LLC, Menlo Park, CA (US)

(72) Inventors: Andrew Lovitt, Redmond, WA (US); Scott Phillip Selfon, Kirkland, WA (US)

(21) Appl. No.: 17/834,806

(22) Filed: Jun. 7, 2022

Related U.S. Application Data
(60) Provisional application No. 63/233,143, filed on Aug. 13, 2021.
(60) Provisional application No. 63/297,594, filed on Jan. 7, 2022.

(51) Int. Cl. H04S 7/00; H04R 5/04; G02B 27/01; G02B 27/00

(52) U.S. Cl. CPC H04S 7/303; H04R 5/04; G02B 27/0179; G02B 27/0093; G02B 2027/0187; G02B 2027/0178

(57) ABSTRACT

A method for providing a world-locked experience to a user of a headset in an immersive reality application includes receiving, from an immersive reality application, a first audio waveform from a first acoustic source to provide to a user of a headset, determining a direction of arrival for the first acoustic source relative to the headset, and providing, to a speaker in the headset, an audio signal including the first audio waveform and intended for an ear of the user of the headset, wherein the audio signal includes a time delay and an amplitude for the first audio waveform based on the direction of arrival for the first acoustic source relative to the user of the headset. A non-transitory, computer-readable medium storing instructions which, when executed by a processor, cause a system to perform the above method, and the system, are also provided.

### CROSS-REFERENCE TO RELATED APPLICATIONS

The present disclosure is related and claims priority under 35 U.S.C. § 119(e) to U.S. Provisional Pat. Appln. No. 63/233,143 entitled AUDIO HARDWARE AND SOFTWARE FOR SMART GLASSES, filed on Aug. 13, 2021, and to U.S. Provisional Pat. Appln. No. 63/297,594 entitled WORLD LOCK SPATIAL AUDIO PROCESSING, filed on Jan. 7, 2022, both to Andrew LOVITT et al., the contents of which applications are hereinafter incorporated by reference, in their entirety, for all purposes.

### BACKGROUND

### Field

The present disclosure is directed to handling sound input and output in wearable headsets. More specifically, embodiments as disclosed herein are directed to handling multiple microphone inputs and speaker outputs in smart glasses for creating a world lock environment in immersive reality applications.

### Related Art

In the field of wearable headsets, many applications include immersion of the user in a virtual world. However, as the user moves in the real world, and rotates his/her head around, typically the sound sources remain fixed in place relative to the wearable headset. While this mismatch between the intended virtual immersion and the user movements may be unnoticeable when the user motion is not sudden, brisk, or continuous, it certainly is detrimental to the quality of the immersive effect on the user.

### BRIEF DESCRIPTION OF THE DRAWINGS

FIG. 1 illustrates an architecture including one or more wearable devices coupled to one another, to a mobile device, a remote server and to a database, according to some embodiments.

FIG. 2 illustrates a smart glass in an environment including multiple acoustic and noise sources, according to some embodiments.

FIG. 3 illustrates a selection of a direction of arrival of an audio source from multiple microphones on a smart glass, according to some embodiments.

FIG. 4 is a flowchart illustrating steps in a method for providing a world-locked immersive experience to a user of a headset, according to some embodiments.

FIG. 5 is a flowchart illustrating steps in a method for providing a world-locked immersive experience to a user of a headset, according to some embodiments.

FIG. 6 is a block diagram illustrating a computer system for implementing a headset and methods for use thereof, according to some embodiments.

In the figures, elements and procedures having the same or similar reference elements have the same or similar attributes and description, unless explicitly stated otherwise.

### SUMMARY

In a first embodiment, a computer-implemented method includes receiving, from an immersive reality application, a first audio waveform from a first acoustic source to provide to a user of a headset. The computer-implemented method also includes determining a direction of arrival for the first acoustic source relative to the headset, and providing, to a speaker in the headset, an audio signal comprising the first audio waveform and intended for an ear of the user of the headset, wherein the audio signal includes a time delay and an amplitude for the first audio waveform based on the direction of arrival for the first acoustic source relative to the user of the headset.

In a second embodiment, a headset includes a processor configured to receive, from an immersive reality application, a first audio waveform from a first acoustic source in a first location, a left speaker, configured to provide the first audio waveform to a left ear of a headset user, and a right speaker, configured to provide the first audio waveform to a right ear of the headset user. The processor is configured to adjust a time delay of the first audio waveform between the left speaker and the right speaker, and to modulate an amplitude of the first audio waveform in the left speaker and the right speaker based on the first location of the first acoustic source.

In a third embodiment, a computer-implemented method includes providing, from an immersive reality application to a headset, a first audio waveform from a first acoustic source, providing, to the headset, an environmental datum that places a user of the headset within a virtual world, based on the immersive reality application, and determining a direction of arrival for the first acoustic source based on a position of the headset and the environmental datum.

In another embodiments, a system includes a memory storing instructions and one or more processors configured to execute the instructions to cause the system to perform a method. The method includes receiving, from an immersive reality application, a first audio waveform from a first acoustic source to provide to a user of a headset. The method also includes determining a direction of arrival for the first acoustic source relative to the headset, and providing, to a speaker in the headset, an audio signal comprising the first audio waveform and intended for an ear of the user of the headset, wherein the audio signal includes a time delay and an amplitude for the first audio waveform based on the direction of arrival for the first acoustic source relative to the user of the headset.

In yet other embodiments, a system includes a first means to store instructions and a second means to execute the instructions to cause the system to perform a method. The method includes receiving, from an immersive reality application, a first audio waveform from a first acoustic source to provide to a user of a headset, determining a direction of arrival for the first acoustic source relative to the headset, and providing, to a speaker in the headset, an audio signal comprising the first audio waveform and intended for an ear of the user of the headset. The audio signal includes a time delay and an amplitude for the first audio waveform based on the direction of arrival for the first acoustic source relative to the user of the headset.

### DETAILED DESCRIPTION

In the following detailed description, numerous specific details are set forth to provide a full understanding of the present disclosure. It will be apparent, however, to one ordinarily skilled in the art, that embodiments of the present disclosure may be practiced without some of these specific details. In other instances, well-known structures and techniques have not been shown in detail so as not to obscure the disclosure.

Audio is a primary interaction modality for enhanced reality applications, including virtual reality (VR) and augmented reality (AR). As part of this, spatial audio can play an important role in allowing for hardware/software-based audio filters, giving users access to novel audio experiences, providing better and more immersive user content creation.

Wearable devices as disclosed herein are configured to collect information so that a relative position and orientation between a world frame anchored to a virtual reality and a wearable frame anchored to the wearable device can be continuously updated and used to provide a fresh position of acoustic sources to the wearable device.

In some embodiments, smart glasses include inertial measurement units (IMU), accelerometers and gyroscopes, and similar sensors providing motion signals that can be integrated to determine a current location and orientation of the smart glass in the real world and also in a virtual world.

Embodiments as disclosed herein include global positioning systems (GPS) providing geolocation coordinates of a headset as disclosed herein. The geolocation coordinates may be supplemented with position and orientation information integrated from the IMU sensors to have accurate information of the headset.

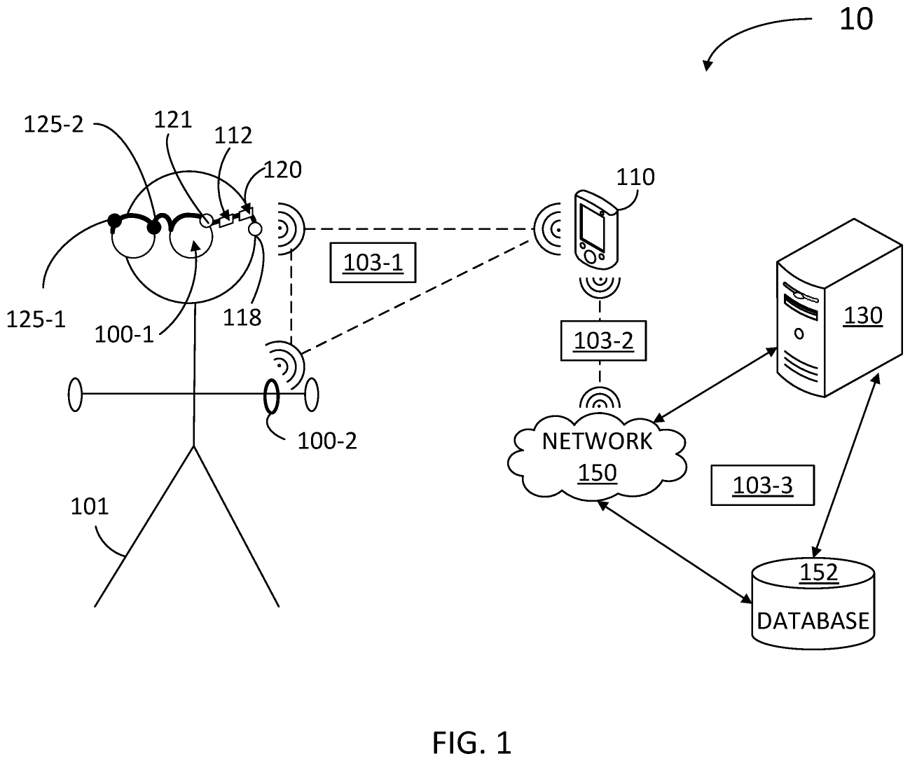

FIG. 1 illustrates an architecture 10 including one or more wearable devices 100-1 and 100-2 (hereinafter, collectively referred to as “wearable devices 100”) with a user 101, coupled to one another, to a mobile device 110, a remote server 130 and to a database 152, according to some embodiments. Wearable devices 100 may include a smart glass or augmented reality headset 100-1 and a wrist-band (100-2 or “watch”), and mobile device 110 may be a smart phone, all of which may communicate with one another via wireless communications and exchange a first dataset 103-1. In some embodiments, mobile device 110 may belong to user 101 as well. Dataset 103-1 may include a recorded video, audio, or some other file or streaming media. The user of wearable devices 100 is also the owner or is associated with mobile device 110.

Mobile device 110 may be communicatively coupled with remote server 130 and database 152 via a network 150, and transmit/share information, files, and the like with one another (e.g., dataset 103-2 and dataset 103-3).

In some embodiments, smart glass 100-1 may include multiple sensors 121 such as inertial measurement units (IMUs), gyroscopes, microphones, cameras, and the like mounted within the frame of AR headset 100-1 or wrist-watch 100-2 or wrist-band. Other sensors 121 that can be included in wearable devices 100 (e.g., smart glasses 100-1, wrist-bands 100-2, and the like) may be magnetometers, microphones, photodiodes and cameras, touch sensors and other electromagnetic devices such as capacitive sensors, a pressure sensor, and the like. Smart glass 100-1 may include an acoustic microphone 125-1 and a contact microphone 125-2 (hereinafter, collectively referred to as “microphones 125”). Acoustic microphone 125-1 receives acoustic signals propagating through the air, as pressure waves. Contact microphone 125-2 may be mechanically coupled to the skin and a bone of the user, e.g., in a nose pad or in an arm of smart glass 100-1, in contact with the user's temple, and the like.

In addition, smart glass 100-1 or any other wearable device 100, or mobile device 110 may include a memory circuit 120 storing instructions, and a processor circuit 112 configured to execute the instructions to cause smart glass 100-1 to perform, at least partially, some of the steps in methods consistent with the present disclosure. In some embodiments, smart glass 100-1, wrist-watch 100-2, wrist-band, or wearable device 100, mobile device 110, server 130 and/or database 152 may further include a communications module 118 enabling the device to wirelessly communicate with remote server 130 via network 150. In some embodiments, communications module 118 can include, for example, radio-frequency hardware (e.g., antennas, filters analog to digital converters, and the like) and software (e.g., signal processing software). Smart glass 100-1 may thus download a multimedia online content (e.g., dataset 103-1) from remote server 130, to perform at least partially some of the operations in methods as disclosed herein. Network 150 may include, for example, any one or more of a local area network (LAN), a wide area network (WAN), the Internet, and the like. Further, the network can include, but is not limited to, any one or more of the following network topologies, including a bus network, a star network, a ring network, a mesh network, a star-bus network, tree or hierarchical network, and the like.

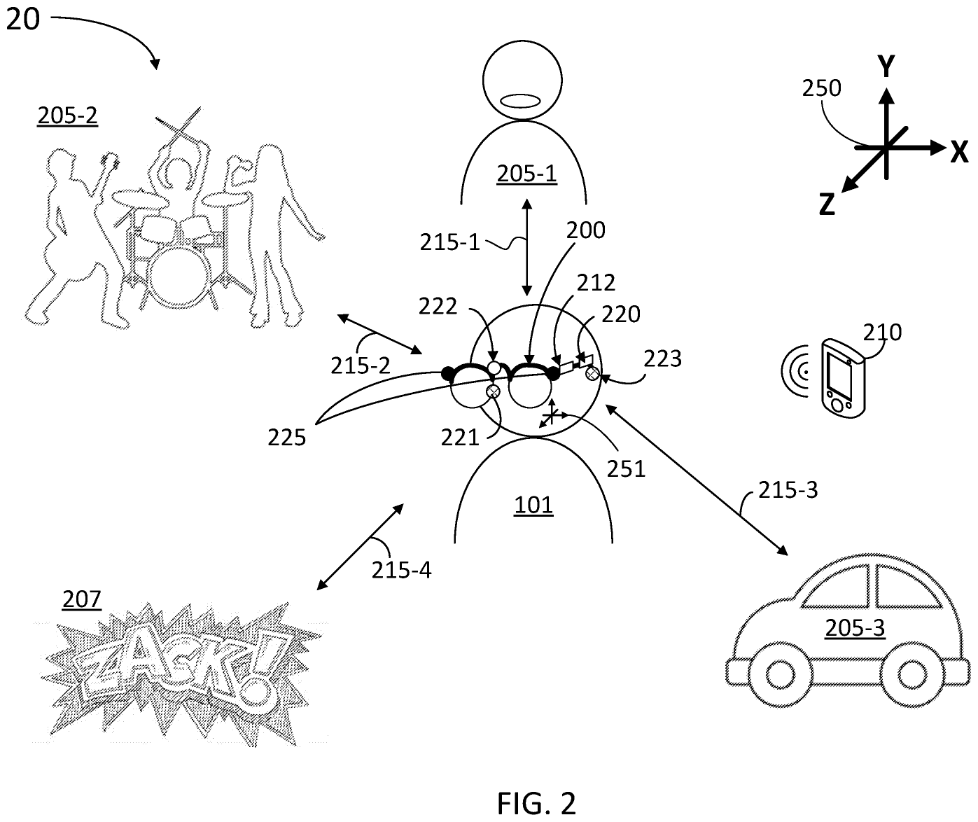

FIG. 2 illustrates a smart glass 200 in an environment 20 including multiple acoustic sources 205-1, 205-2, and 205-3 (hereinafter, collectively referred to as “acoustic sources”) and noise (e.g., background interference) 207, according to some embodiments. Smart glass 200 may belong to a user 101 and may communicate wirelessly with a mobile device 210 also with user 101. Smart glass 200 includes a camera 222, one or more acoustic/contact microphones 225, an inertial motion unit (IMU) sensor or gyroscope 221, and at least one speaker 223, mounted on the frame (e.g., nose pads, arms, rim, and the like) of smart glass 200. Acoustic sources 205 may include a person talking to user 101 (e.g., source 205-1), a music band playing in the background (e.g., source 205-2), or a moving source (e.g., source 205-3, a car, train, plane, toy, drone, or a moving person). A noise source 207 may be a background noise or interference, environmental noise, and the like (e.g., kitchen noise in a restaurant, the humming of a motor engine or machine).

Smart glass 200 may also include memory circuit 220 storing instructions and a processor circuit 212 configured to execute the instructions to perform one or more operations consistent with methods as disclosed herein. For example, by collecting the signals from each of acoustic sources 205, including noise 207, processor circuit 212 may be configured to determine a direction of arrival (DA) 215-1, 215-2, 215-3, and 215-4 (hereinafter, collectively referred to as “DAs 215”, e.g., DA 215-1, DA 215-2, DA 215-3, and DA 215-4) for a sound waveform from each of acoustic sources 205, including noise 207. To do this, processor 212 may also provide a common clock signal to all acoustic microphones 225, so that the time of arrival at each microphone 225 of the different waveforms from each acoustic source 205 and noise 207 may be registered and stored in memory circuit 220. In some embodiments, the clock signal may be separate for each, or at least some, of microphones 225. In this case, the different clock signals may be synchronized at a centralized processor 212. By determining the different time of arrival of a waveform from each acoustic source 205 to microphones 225, a direction of the source (e.g., DA 215) relative to smart glass 200 may be established.

In some embodiments, memory circuit 220 may also include an immersive reality application that provides instructions to processor 212 to project a virtual feature onto the display in at least one of the eyepieces of smart glass 200. Accordingly, at least one or more of acoustic sources 205 and noise 207 may be a virtual feature embedded in the display of smart glass 200. Moreover, in some embodiments, at least one or more of acoustic sources 205 and noise 207 may be a virtual feature which, while not displayed in one of the eyepieces of smart glass 200, may still provide acoustic signals to user 101 via the one or two speakers 223, positioned near each of the ears of user 101.

In addition to determining DAs 215 from different acoustic sources 205 and noise 207, processor circuit 212 may use signals from IMU sensor 221 to determine position, location, and orientation of smart glasses 200 relative to the real world (e.g., as defined by gravity). Accordingly, by integrating signals from IMU sensor 221 or communicating with a geolocation system, processor 212 may identify a location for smart glass 200, and a position and location of each of acoustic sources 205. With this information, processor 212 may establish a world frame 250 anchored to the outside world, and a glass frame 251 anchored to the frame of smart glass 200. Moreover, processor 212 determines a relative position and orientation between world frame 250 and glass frame 251. Using this information, processor 212 may further be able to provide and update a virtual DA for a virtual acoustic source, as user 101 moves along and rotates the head (and consequently, smart glasses 200 as well). The updating of the perceived direction of audio can be done at a frequency based on the system design. For example, the update frequency can be very slow for static, low motion scenes, or slowly moving acoustic sources and users. In some embodiments, the update frequency can be higher for highly dynamic environments or fast-moving acoustic sources. In some embodiments, especially for a fast-moving acoustic source 205, the updating of the acoustic signal or audio waveform may further include adding a Doppler shift to the frequency of the waveform to provide a more realistic effect. Processor 212 then provides the speakers 223 on each of the ears of user 101 an appropriate delay and relative intensity consistent with the virtual or updated direction of arrival 215 of the waveform from the virtual source. Accordingly, having relative position and orientation between world frame 250 and glass frame 251, processor 212 in smart glass 200 may be configured to provide a world-lock spatial audio processing to user 101, for an immersive application.

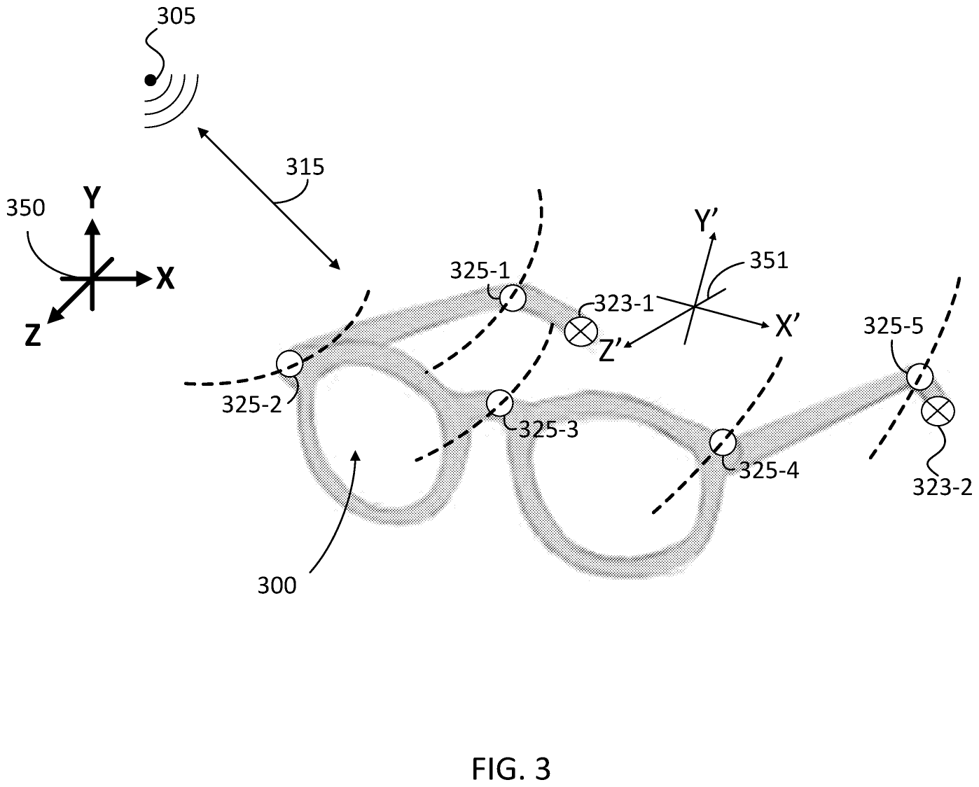

FIG. 3 illustrates a selection of a direction of arrival 315 of an audio source 305 from multiple microphones 325-1, 325-2, 325-3, 325-4, and 325-5 (hereinafter, collectively referred to as microphones 325, e.g., mic 325-1, mic 325-2, mic 325-3, and mic 325-4, and mic 325-5) on smart glass 300, according to some embodiments. Accordingly, DA 315 may be selected based on the difference in time of arrival of a sound waveform to each of the spatially distributed microphones 325 on smart glass 300. In some embodiments, it may suffice to know the difference in time of arrival to assess DA 315 as a unit vector having two direction cosines. In some embodiments, the system may be able to determine a specific location of acoustic source 305 relative to smart glass 300 and even relative to geocoordinates. Smart glass 300 may also include speakers 323-1 and 323-2 (hereinafter, collectively referred to as “speakers 323”), configured to produce a stereo sound from audio source 305 along DA315. In some embodiments, DA315 is a vector oriented relative to either one of a world frame 350 and a glass frame 351, which frames may be oriented arbitrarily relative to each other.

In some embodiments, the assessment of DA 315 and location of acoustic source 305 may include resolving a linear regression problem associating times of arrival or sound signals to each of microphones 325 based on the DA 315 and a speed of sound. To determine the time of arrival, the system may be configured to select a characteristic portion of the waveform generated by acoustic source 305, that may be easily identifiable using digital filters at each of microphones 325. In some embodiments, and to enhance accuracy, the entire waveform or a substantive portion of it may be used to match the acoustic source origin. Other filtering techniques using hardware or software may be implemented, to identify distinct acoustic sources involved in any given event. In some embodiments, the software may include non-linear techniques such as non-linear regression, neural networks, machine learning, and artificial intelligence. Accordingly, in some embodiments, the system may include geolocation sensors and devices (e.g., IMU sensor 221) to better identify location and distances in environment 20 at a time of the event recording. The glass frame and the world frame are illustrated, showing a slight relative shift between the two due to a smart glass movement.

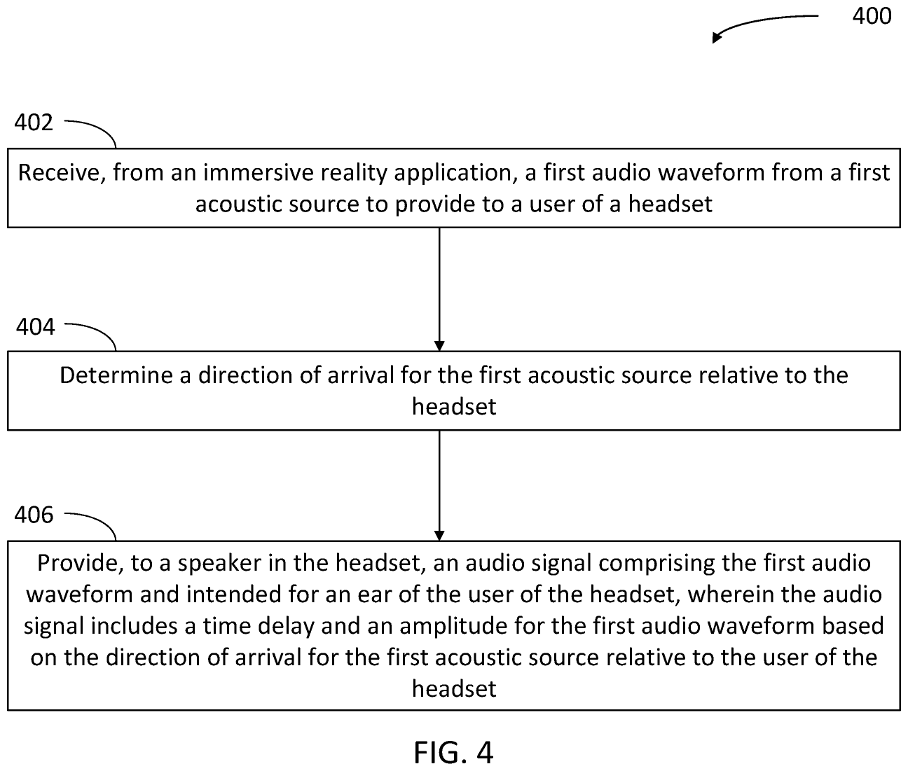

FIG. 4 is a flowchart illustrating steps in a method 400 for providing a world-locked immersive experience to a user of a headset, according to some embodiments. In some embodiments, at least one or more of the steps in method 400 may be performed by a processor executing instructions stored in a memory in either one of a smart glass or other wearable device on a user's body part (e.g., head, arm, wrist, leg, ankle, finger, toe, knee, shoulder, chest, back, and the like). In some embodiments, at least one or more of the steps in method 400 may be performed by a processor executing instructions stored in a memory, wherein either the processor or the memory, or both, are part of a mobile device for the user, a remote server, or a database, communicatively coupled with each other via a network (e.g., processor 112, memory 120, mobile device 110, server 130, and network 150). Moreover, the mobile device, the smart glass, and the wearable devices may be communicatively coupled with each other via a wireless communication system and protocol (e.g., communications module 118 including a radio, Wi-Fi, Bluetooth, near-field communication—NFC—and the like). In some embodiments, a method consistent with the present disclosure may include one or more steps from method 400 performed in any order, simultaneously, quasi-simultaneously, or overlapping in time.

Step 402 includes receiving, from an immersive reality application, a first audio waveform from a first acoustic source to provide to a user of a headset. In some embodiments, the first acoustic source is a virtual source, and step 402 further includes providing an image of the virtual source to a display formed in at least one eyepiece of the headset. In some embodiments, step 402 further includes receiving a signal from an inertial motion sensor to determine a position and an orientation of the headset relative to a world frame and updating the time delay and the amplitude of the audio signal based on the position and the orientation of the headset relative to the world frame. In some embodiments, step 402 further includes receiving, from the immersive reality application, a second audio waveform from a second acoustic source, wherein providing the audio signal to the speaker in the headset includes inserting the second audio waveform in the audio signal with a time delay and an amplitude based on a relative location between the second acoustic source and the headset.

Step 404 includes determining a direction of arrival for the first acoustic source relative to the headset. In some embodiments, step 404 includes receiving a location of the first acoustic source from the immersive reality application and determining a location of the headset based on a position signal received from an inertial motion sensor in the headset. In some embodiments, step 404 includes determining a relative position and orientation between a world frame anchored on a virtual reality provided by the immersive reality application and a headset frame anchored on the headset. In some embodiments, the first acoustic source is a virtual source, and step 404 includes receiving a location of the virtual source from the immersive reality application.

Step 406 includes providing, to a speaker in the headset, an audio signal including the first audio waveform and intended for an ear of the user of the headset, wherein the audio signal includes a time delay and an amplitude for the first audio waveform based on the direction of arrival for the first acoustic source relative to the user of the headset. In some embodiments, step 406 includes providing a left audio signal to a left speaker acoustically coupled to a left ear of the user, and a right audio signal for a right speaker acoustically coupled with a right ear of the user, and the time delay is a relative time delay between the left audio signal and the right audio signal. In some embodiments, step 406 includes updating the time delay and the amplitude of the audio signal based on a position of the first acoustic source. In some embodiments, the first acoustic source is a moving source, and step 406 includes updating the time delay and the amplitude of the audio signal based on a displacement of the moving source relative to the headset.

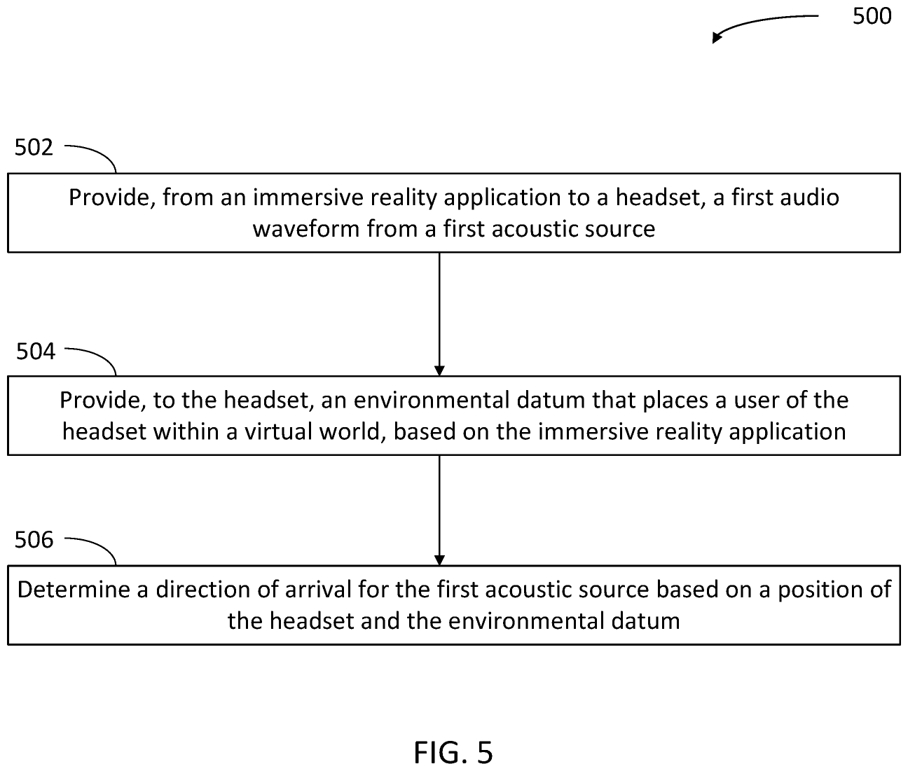

FIG. 5 is a flowchart illustrating steps in a method 500 for providing a world-locked immersive experience to a user of a headset, according to some embodiments. In some embodiments, at least one or more of the steps in method 500 may be performed by a processor executing instructions stored in a memory in either one of a smart glass or other wearable device on a user's body part (e.g., head, arm, wrist, leg, ankle, finger, toe, knee, shoulder, chest, back, and the like). In some embodiments, at least one or more of the steps in method 500 may be performed by a processor executing instructions stored in a memory, wherein either the processor or the memory, or both, are part of a mobile device for the user, a remote server, or a database, communicatively coupled with each other via a network (e.g., processor 112, memory 120, mobile device 110, server 130, and network 150). Moreover, the mobile device, the smart glass, and the wearable devices may be communicatively coupled with each other via a wireless communication system and protocol (e.g., communications module 118 including a radio, Wi-Fi, Bluetooth, near-field communication—NFC—and the like). In some embodiments, a method consistent with the present disclosure may include one or more steps from method 500 performed in any order, simultaneously, quasi-simultaneously, or overlapping in time.

Step 502 includes providing, from an immersive reality application to a headset, a first audio waveform from a first acoustic source.

Step 504 includes providing, to the headset, an environmental datum that places a user of the headset within a virtual world, based on the immersive reality application.

Step 506 includes determining a direction of arrival for the first acoustic source based on a position of the headset and the environmental datum. In some embodiments, step 506 includes receiving, from an inertial motion sensor, a location and orientation information of the headset, wherein determining a direction of arrival for the first acoustic source includes updating the direction of arrival based on the location and orientation information of the headset. In some embodiments, the first acoustic source is a moving source, and step 506 includes updating the direction of arrival based on a predetermined trajectory of the moving source. In some embodiments, step 506 includes determining a relative position and orientation between a virtual world frame anchored on the environmental datum and a headset frame anchored on the headset. In some embodiments, step 506 further includes determining a time delay and an amplitude of the first audio waveform for a stereo-acoustic signal for the user of the headset, wherein the stereo-acoustic signal is based on the direction of arrival for the first acoustic source.

### Hardware Overview

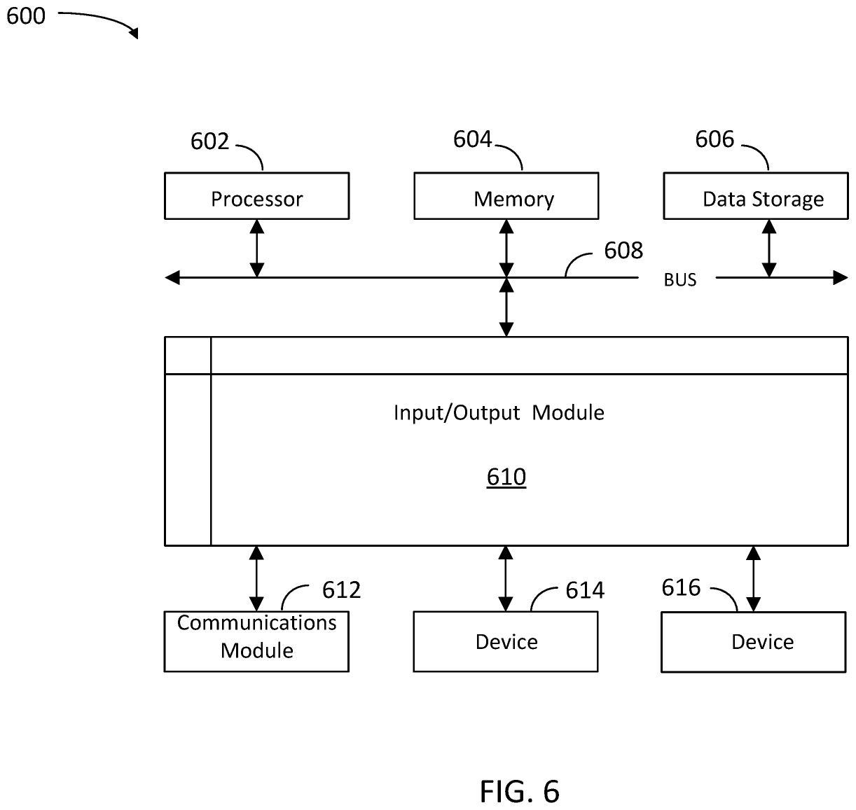

FIG. 6 is a block diagram illustrating a computer system for implementing a headset and methods for use thereof, according to some embodiments. In certain aspects, computer system 600 may be implemented using hardware or a combination of software and hardware, either in a dedicated server, or integrated into another entity, or distributed across multiple entities. Computer system 600 may include a desktop computer, a laptop computer, a tablet, a phablet, a smartphone, a feature phone, a server computer, or otherwise. A server computer may be located remotely in a data center or be stored locally.

Computer system 600 includes a bus 608 or other communication mechanism for communicating information, and a processor 602 (e.g., processor 112) coupled with bus 608 for processing information. By way of example, the computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 604 (e.g., memory 120), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, e.g., one or more modules of computer program instructions encoded on a computer-readable medium for execution by, or to control the operation of, the computer system 600, and according to any method well known to those of skill in the art, including, but not limited to, computer languages such as data-oriented languages (e.g., SQL, dB ase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 604 may also be used for storing temporary variable or other intermediate information during execution of instructions to be executed by processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 600 further includes a data storage device 606 such as a magnetic disk or optical disk, coupled with bus 608 for storing information and instructions. Computer system 600 may be coupled via input/output module 610 to various devices. Input/output module 610 can be any input/output module. Exemplary input/output modules 610 include data ports such as USB ports. The input/output module 610 is configured to connect to a communications module 612. Exemplary communications modules 612 include networking interface cards, such as Ethernet cards and modems. In certain aspects, input/output module 610 is configured to connect to a plurality of devices, such as an input device 614 and/or an output device 616. Exemplary input devices 614 include a keyboard and a pointing device, e.g., a mouse or a trackball, by which a consumer can provide input to the computer system 600. Other kinds of input devices 614 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 616 include display devices, such as an LCD (liquid crystal display) monitor, for displaying information to the consumer.

According to one aspect of the present disclosure, smart glass 100-1 can be implemented, at least partially, using a computer system 600 in response to processor 602 executing one or more sequences of one or more instructions contained in memory 604. Such instructions may be read into memory 604 from another machine-readable medium, such as data storage device 606. Execution of the sequences of instructions contained in main memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 600 can include clients and servers. A client and server are generally remote from each other and typically interact through a communication network. The relationship of client and server arises by virtue of computer programs running on the respective computers and having a client-server relationship to each other. Computer system 600 can be, for example, and without limitation, a desktop computer, laptop computer, or tablet computer. Computer system 600 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires forming bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method, comprising:
receiving, from an immersive reality application, a first audio waveform from a first acoustic source to provide to a user of a headset;
determining a direction of arrival for the first acoustic source relative to the headset; and
providing, to a speaker in the headset, an audio signal comprising the first audio waveform and intended for an ear of the user of the headset, wherein the audio signal includes a time delay and an amplitude for the first audio waveform based on the direction of arrival for the first acoustic source relative to the user of the headset.

2. The computer-implemented method of claim 1, wherein the first acoustic source is a virtual source, further comprising providing an image of the virtual source to a display formed in at least one eyepiece of the headset.

3. The computer-implemented method of claim 1, further comprising receiving a signal from an inertial motion sensor to determine a position and an orientation of the headset relative to a world frame, and updating the time delay and the amplitude of the audio signal based on the position and the orientation of the headset relative to the world frame.

4. The computer-implemented method of claim 1, further comprising receiving, from the immersive reality application, a second audio waveform from a second acoustic source, wherein providing the audio signal to the speaker in the headset comprises inserting the second audio waveform in the audio signal with a time delay and an amplitude based on a relative location between the second acoustic source and the headset.

5. The computer-implemented method of claim 1, wherein determining the direction of arrival of the first audio waveform comprises receiving a location of the first acoustic source from the immersive reality application and determining a location of the headset based on a position signal received from an inertial motion sensor in the headset.

6. The computer-implemented method of claim 1, wherein determining the direction of arrival of the first audio waveform comprises determining a relative position and orientation between a world frame anchored on a virtual reality provided by the immersive reality application and a headset frame anchored on the headset.

7. The computer-implemented method of claim 1, wherein the first acoustic source is a virtual source, and determining the direction of arrival for the first acoustic source comprises receiving a location of the virtual source from the immersive reality application.

8. The computer-implemented method of claim 1, wherein providing the audio signal intended for an ear of the user comprises providing a left audio signal to a left speaker acoustically coupled to a left ear of the user, and a right audio signal for a right speaker acoustically coupled with a right ear of the user, and the time delay is a relative time delay between the left audio signal and the right audio signal.

9. The computer-implemented method of claim 1, further comprising updating the time delay and the amplitude of the audio signal based on a position of the first acoustic source.

10. The computer-implemented method of claim 1, wherein the first acoustic source is a moving source, further comprising updating the time delay and the amplitude of the audio signal based on a displacement of the moving source relative to the headset.

11. A headset, comprising:
a processor configured to receive, from an immersive reality application, a first audio waveform from a first acoustic source in a first location;
a left speaker, configured to provide the first audio waveform to a left ear of a headset user; and
a right speaker, configured to provide the first audio waveform to a right ear of the headset user, wherein the processor is configured to adjust a time delay of the first audio waveform between the left speaker and the right speaker, and to modulate an amplitude of the first audio waveform in the left speaker and the right speaker based on the first location of the first acoustic source.

12. The headset of claim 11, further comprising an inertial motion unit sensor to provide a motion signal to the processor, wherein the processor is configured to integrate the motion signal to determine a relative position and orientation between a headset frame and a world frame, and to update the time delay of the first audio waveform and the amplitude of the first audio waveform in the left speaker and the right speaker based on the relative position and orientation between the headset frame and the world frame.

13. The headset of claim 11, wherein the first acoustic source is a virtual source, further comprising a display on an eyepiece of the headset, the display configured to provide an image of the virtual source in the immersive reality application for the headset user.

14. The headset of claim 11, further comprising a memory circuit storing instructions which, when executed by the processor, cause the headset to perform the immersive reality application.

15. The headset of claim 11, wherein the immersive reality application is installed in a mobile device communicatively coupled with the headset, further comprising a communications module configured to provide the first audio waveform from the mobile device to the processor.

16. A computer-implemented method, comprising:
providing, from an immersive reality application to a headset, a first audio waveform from a first acoustic source;
providing, to the headset, an environmental datum that places a user of the headset within a virtual world, based on the immersive reality application; and
determining a direction of arrival for the first acoustic source based on a position of the headset and the environmental datum.

17. The computer-implemented method of claim 16, further comprising receiving, from an inertial motion sensor, a location and orientation information of the headset, wherein determining a direction of arrival for the first acoustic source comprises updating the direction of arrival based on the location and orientation information of the headset.

18. The computer-implemented method of claim 16, wherein the first acoustic source is a moving source, and determining a direction of arrival for the first acoustic source comprises updating the direction of arrival based on a predetermined trajectory of the moving source.

19. The computer-implemented method of claim 16, wherein determining a direction of arrival for the first acoustic source comprises determining a relative position and orientation between a virtual world frame anchored on the environmental datum and a headset frame anchored on the headset.

20. The computer-implemented method of claim 16, further comprising determining a time delay and an amplitude of the first audio waveform for a stereo-acoustic signal for the user of the headset, wherein the stereo-acoustic signal is based on the direction of arrival for the first acoustic source.
